(19) United States
(12) Patent Application Publication
(10) Pub. No.: US 2012/0106751 A1
(43) Pub. Date: May 3, 2012

(54) METHODS AND APPARATUS FOR WIRELESS MICROPHONE SYNCHRONIZATION

(75) Inventors: Junyi Li, Chester, NJ (US); Mathew Scott Corson, Gillette, NJ (US); Thomas J. Richardson, South Orange, NJ (US); Frank A. Lane, Easton, PA (US)

(73) Assignee: QUALCOMM Incorporated, San Diego, CA (US)

(21) Appl. No.: 13/217,182

(22) Filed: Aug. 24, 2011

Related U.S. Application Data
(60) Provisional application No. 61/376,803, filed on Aug. 25, 2010.

(51) Int. Cl. H04B 3/00

(52) U.S. Cl. 381/77

(57) ABSTRACT

Methods and apparatus related to timing synchronization used in a wireless microphone system to reduce and/or minimize interference are described. A wireless microphone receiver in some embodiments performs open loop timing control based on signals from an adjacent wireless microphone receiver and participates in closed loop timing control of wireless microphone transmitters which communicate with the particular wireless microphone receiver. The closed loop timing control includes instructing individual wireless microphone transmitters to advance or retard their symbol timing so that symbols transmitted by different wireless microphone transmitters are received in a synchronized manner at the wireless microphone receiver. The closed loop timing control allows a wireless microphone receiver to control wireless microphone transmitters to take into consideration their different distances to the receiver and the differing transmission times associated with the wireless microphone transmitters at different locations.

### RELATED APPLICATIONS

This application claims the benefit of U.S. Provisional Patent Application Ser. No. 61/376,803, filed Aug. 25, 2010, titled “Wireless Microphone Apparatuses and Methods” which is hereby expressly incorporated by reference in its entirety.

### FIELD

Various embodiments relate to wireless communications, and more particularly, to methods and apparatus for synchronizing wireless microphone transmitters and receivers in a wireless microphone communications system.

### BACKGROUND

Wireless microphone systems often include a plurality of wireless microphones which transmit audio signals to a microphone receiver. Multiple microphone receivers located at different locations may be used. Normally, there are multiple wireless microphones for each wireless microphone receiver in a system.

The presence of multiple wireless microphones in near proximity to each other can result in signal interference. Signal interference reduces the number of microphones that can operate in an area using a given, e.g., limited, amount of bandwidth.

In the case of cellular base stations, multiple base stations are often highly synchronized with the base stations being synchronized to a common timing signal source. While such an approach can reduce interference between cells, synchronization of multiple base stations to a common timing source to a level of accuracy down to the time of a symbol transmission time period can be costly to achieve and may not be justified, from a cost perspective, for applications such as wireless microphone systems.

In the case of OFDM communications systems, when multiple devices are communicating with a single receiver, symbol timing can be particularly important so that symbols which arrive at a receiver from different devices are received in a synchronized manner thereby minimizing inter-symbol interference.

In view of the above discussion, it should be appreciated that it would be desirable if method and apparatus were developed which would facilitate timing synchronization in a digital wireless microphone system. It would be desirable if at least some of the methods and/or apparatus could be implemented at a reasonable cost making the methods and apparatus suitable for cost conscious wireless microphone users.

### SUMMARY

Methods and apparatus related to timing synchronization used in a wireless microphone system to reduce and/or minimize interference in a system are described.

Timing may be based on timing reference signals transmitted by wireless microphone receivers and/or wireless microphone transmitters.

In accordance with one feature of some embodiments, a wireless microphone receiver broadcasts a timing reference signal. A neighboring wireless microphone receiver which detects the timing reference signal from another wireless microphone receiver and performs an open loop timing control method to synchronize its symbol timing to the symbol timing of the neighbor wireless microphone receiver. Thus, in some but not all embodiments, at least some level of symbol timing synchronization is maintained between adjacent wireless microphone receivers but the level may not be as precise as in systems where devices are closely synchronized to a common GPS reference signal. Thus, the first wireless microphone receiver in an area operates as a timing master with subsequent wireless microphone receivers performing open loop timing control to synchronize their symbol timing to that of the master wireless microphone receiver.

In addition to broadcasting a timing signal, a wireless microphone receiver participates in closed loop timing control of wireless microphone transmitters which communicate with the particular wireless microphone receiver. Thus, a wireless microphone transmitter sends closed loop timing control signals to wireless microphone transmitters from which it receives audio data. The closed loop timing control includes instructing individual wireless microphone transmitters to advance or retard their symbol timing so that symbols transmitted by different wireless microphone transmitters are received in a synchronized manner at the wireless microphone receiver. The closed loop timing control allows a wireless microphone receiver to control wireless microphone transmitters to take into consideration their different distances to the receiver and the differing transmission times associated with the wireless microphone transmitters at different locations.

By performing open loop timing between wireless microphone receivers in an area and by performing closed loop timing control of individual wireless microphone transmitters communicating with a wireless microphone receiver, interference due to symbol timing differences between wireless microphones communicating with the same receiver, e.g., using different tones during the same symbol time can be reduced. In addition, interference between wireless microphone transmitters corresponding to different wireless microphone receivers is also reduced or controlled thanks to the open loop symbol timing control between nearby wireless microphone receivers.

An exemplary method of operating a first wireless microphone transmitter, in accordance with some embodiments, comprises: receiving a timing reference signal transmitted by a wireless microphone receiver within communications range of said first wireless microphone transmitter; transmitting a signal to the wireless microphone receiver; and receiving a closed loop symbol timing control signal from the wireless microphone receiver, said closed loop symbol timing control signal controlling symbol timing of said first wireless microphone transmitter.

An exemplary first wireless microphone transmitter in accordance with some embodiments, comprises: at least one processor configured to: receive a timing reference signal transmitted by a wireless microphone receiver within communications range of said first wireless microphone transmitter; transmit a signal to the wireless microphone receiver; and receive a closed loop symbol timing control signal from the wireless microphone receiver, said closed loop symbol timing control signal controlling symbol timing of said first wireless microphone transmitter. The exemplary first wireless microphone transmitter further comprises memory coupled to the at least one processor.

An exemplary method of operating a wireless microphone receiver, in accordance with some embodiments, comprises: transmitting a timing reference signal; receiving a first signal from a first wireless microphone transmitter; and transmitting, to the first wireless microphone transmitter, a first closed loop symbol timing control signal used to control symbol timing of said first wireless microphone transmitter. In some embodiments the exemplary method of operating the wireless microphone receiver further includes determining a symbol timing adjustment to be made by the first wireless microphone transmitter to synchronize to a target symbol receive time to which multiple wireless microphone transmitters are synchronized. An exemplary wireless microphone receiver, in accordance with some embodiments, comprises: at least one processor configured to: transmit a timing reference signal; receive a first signal from a first wireless microphone transmitter; and transmit, to the first wireless microphone transmitter, a first closed loop symbol timing control signal used to control symbol timing of said first wireless microphone transmitter. The exemplary wireless microphone receiver further comprises memory coupled to the at least one processor.

While various embodiments have been discussed in the summary above, it should be appreciated that not necessarily all embodiments include the same features and some of the features described above are not necessary but can be desirable in some embodiments. Numerous additional features, embodiments and benefits of various embodiments are discussed in the detailed description which follows.

### BRIEF DESCRIPTION OF THE FIGURES

FIG. 1 illustrates an exemplary wireless microphone communications system, in accordance with various exemplary embodiments.

FIG. 2 is a drawing illustrating the steps and associated signaling exchange between a wireless microphone receiver and one or more wireless microphone transmitters, in accordance with various exemplary embodiments.

FIG. 3 illustrates a timing diagram where exemplary signals received at a wireless microphone receiver from two wireless microphone transmitters are not synchronized with the microphone receiver's receive symbol timing.

FIG. 4 is a timing diagram that illustrates a scenario where the received signals from two wireless microphone transmitters are synchronized with the wireless microphone receiver's receive symbol timing.

FIG. 5 is a flowchart of an exemplary method of operating a wireless microphone receiver, in accordance with an exemplary embodiment.

FIG. 6 is an exemplary wireless microphone receiver device in accordance with an exemplary embodiment.

FIG. 7 is an assembly of modules which may be used in the exemplary wireless microphone receiver device of FIG. 6.

FIG. 8 is a flowchart of an exemplary method of operating a first wireless microphone transmitter, in accordance with an exemplary embodiment.

FIG. 9 illustrates an exemplary first wireless microphone transmitter in accordance with an exemplary embodiment.

FIG. 10 is an assembly of modules which may be used in the exemplary first wireless microphone transmitter of FIG. 9.

FIG. 11 illustrates an exemplary time frequency structure of exemplary communications channels which can be used for microphone communications, e.g., microphone audio data and control signaling communications, in the exemplary wireless microphone communications system of FIG. 1.

### DETAILED DESCRIPTION

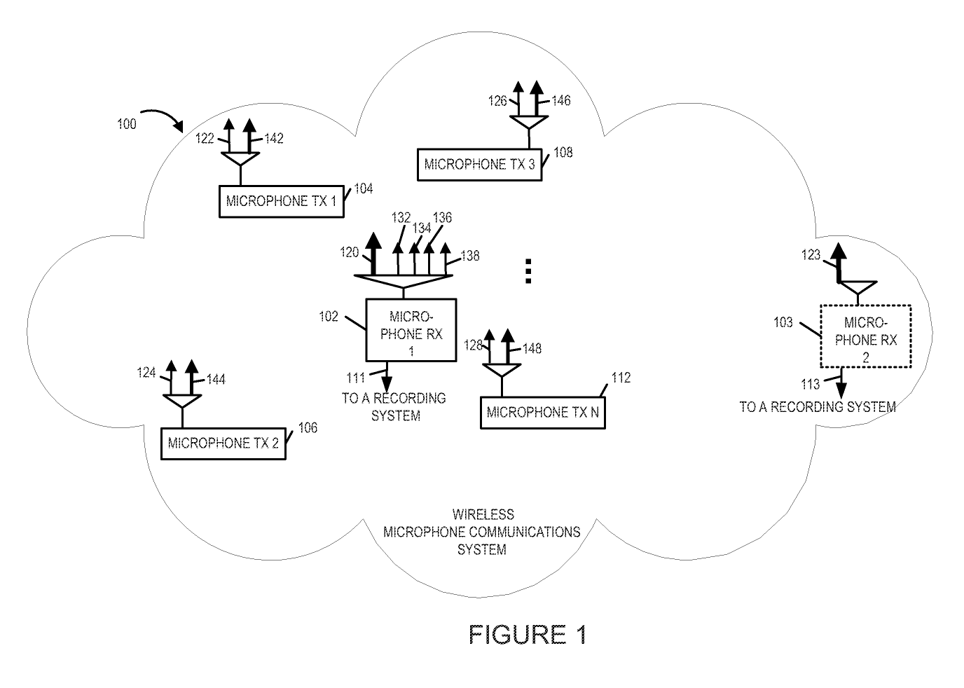

FIG. 1 is a drawing of an exemplary wireless microphone system 100, in accordance with an exemplary embodiment. Exemplary wireless microphone system 100 includes a plurality of wireless microphone devices, e.g., wireless microphone receivers and microphone transmitters. In the exemplary system 100 illustrated in FIG. 1, wireless microphone receiver 1 102 is serving a plurality of wireless microphone transmitters (wireless microphone transmitter 1 104, wireless microphone transmitter 2 106, wireless microphone transmitter 3 108, . . . , wireless microphone transmitter N 112. In some embodiments, there are multiple wireless microphone receivers in exemplary system 100 such as, e.g., wireless microphone receiver 2 103. In embodiments, with multiple wireless microphone receivers, a first wireless microphone receiver, e.g., receiver 102 may be serving a first subset of the wireless microphone transmitters while a second wireless microphone receiver, e.g., receiver 103 may be serving a second subset of the wireless microphone receivers. In some embodiments, the selection of which wireless microphone receiver is to serve which wireless microphone transmitters is a function of location, channel gain, interference, and/or loading. In some embodiments, at least some of the wireless microphone transmitters may, and sometimes, do have links with multiple wireless microphone receivers supporting audio uplink. In various embodiments, in which there are multiple wireless microphone receivers, the wireless microphone receivers synchronize themselves, with a first wireless microphone receiver serving as a master with regard to timing synchronization and a second wireless microphone receiver serving as a slave.

Microphone transmitter devices in system 100 transmit and/or receive signals, e.g., audio signals, control signals, feedback signals etc., to and/or from the wireless microphone receiver 102. The wireless microphone receiver 102 communicates with various wireless microphone transmitters in the system, e.g., via wireless links. The wireless microphone receiver 102 provides access to a recording system and/or other network resources, via a wired or fiber network connection 111. Similarly, wireless microphone receiver 2 103, when included in the system 100, may, and sometimes does, communicate with various wireless microphone transmitters in the system, e.g., via wireless links. The wireless microphone receiver 2 103 provides access to a recording system and/or other network resources, via a wired or fiber network connection 113.

In accordance with one feature, wireless microphone receiver 102 broadcasts a timing reference signal 120. One or more wireless microphone transmitters, e.g., microphone transmitters 104, 106, 108, . . . , and 112, in the communications range of the wireless microphone receiver 102 which detect the timing reference signal 120 perform an open loop timing control method to synchronize to the timing used in the system 100 for communicating with the wireless microphone receiver 102. The wireless microphone transmitters 104, 106, 108, . . . , and 112, transmit signals (122, 124, 126, . . . , 128) respectively, to the microphone receiver 102, after performing the open loop symbol timing synchronization operation.

The wireless microphone receiver 102 participates in closed loop timing control of wireless microphone transmitters it is serving. The wireless microphone receiver 102 transmits closed loop timing controls signals (130, 132, 134, . . . , 136) to the individual wireless microphone transmitters (104, 106, 108, . . . , 112) instructing them to advance or retard their symbol timing so that symbols transmitted by different wireless microphone transmitters are received in a synchronized manner at the wireless microphone receiver 102. The closed loop timing control allows the wireless microphone receiver 102 to control wireless microphone transmitters to take into consideration effects due to oscillator differences in different devices, the effect of motion, their different distances to the microphone receiver, signal path difference, and the differing transmission times associated with the transmitters at different locations.

Consider that exemplary wireless microphone receiver 1 102 is the master wireless microphone receiver in system 100. Wireless microphone receiver 2 103, acting as a slave device with respect to timing reference, receives timing reference signal 120 from wireless microphone receiver 120, synchronizes with respect to signal 120. Wireless microphone receiver 2 103 generates and transmits its own timing reference signal 123. Alternatively, wireless microphone receiver 2 103 may be the master and wireless microphone receiver 1 102 may be the slave device with respect to timing reference. In some embodiments, the decision as to which of multiple wireless microphone receivers in a local vicinity is the master timing reference is dependent upon power on order, e.g., the first wireless microphone receiver device sending out its timing reference signals is the master.

In addition to control signals, each of the wireless microphone transmitters (104, 106, 108, . . . , 112) generates and transmits audio data signals (142, 144, 146, . . . , 148), respectively. In some such embodiments, the audio data signals are communicated in a different frequency band than the band used to communicate various control signals including closed loop timing synchronization control signals.

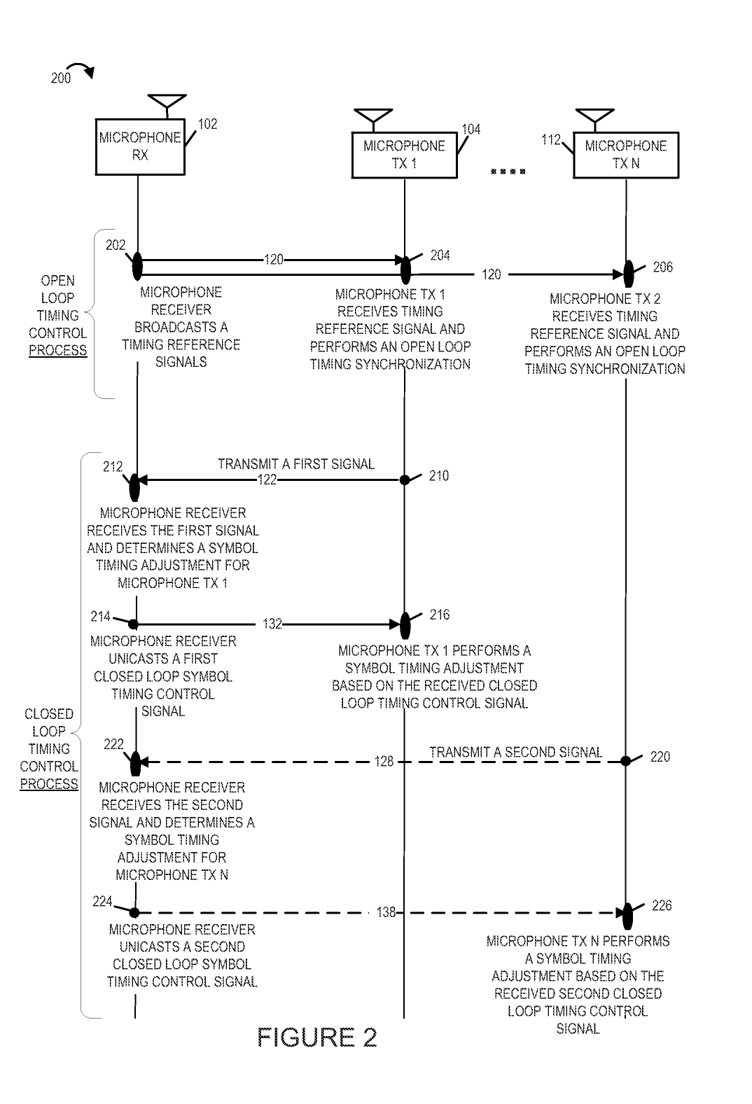

FIG. 2 is a drawing 200 illustrating the steps and associated signaling used in one exemplary embodiment where a wireless microphone receiver, e.g., wireless microphone receiver 102, determines whether a symbol timing adjustment is required by one or more wireless microphone transmitters communicating with the microphone receiver 102 so that the signals received from the wireless microphone transmitters are synchronized with the receiver symbol timing, e.g., to within a predetermined tolerance. To facilitate better understanding of the exemplary process illustrated in FIG. 2, consider the system shown in FIG. 1. Various devices which exchange signaling and/or perform one or more operations to achieve timing synchronization and/or to reduce interference are shown on the top, and include wireless microphone receiver 102, and wireless microphone transmitters (wireless microphone transmitter 1 104, . . . , wireless microphone N 112). One exemplary process where open loop timing control and closed loop symbol timing control signaling is used to achieve timing synchronization is discussed below. Various signals, messages that may be exchanged between the microphone devices are shown using arrows.

In FIG. 2 example the process is initiated by the wireless microphone receiver 102. In step 202 the wireless microphone receiver transmits, e.g., broadcasts, a timing reference signal to various microphone devices in the system 100. The microphone devices, e.g., microphone transmitters which receive the timing reference signal derive system timing structure information and/or other information from the received broadcast timing reference signal so that the microphone devices operating in the system may know when to listen, e.g., for control signals, and when to transmit to the microphone receiver 102 in the system 100. The wireless microphone transmitters perform an open loop timing control process to synchronize with the timing used by the microphone receiver 102, based on the timing reference signal 120.

As will be discussed below in steps 212 to 226 the wireless microphone receiver 102 participates in closed loop timing control of wireless microphone transmitters 104, 106, . . . , 112 which communicate with microphone receiver 102. In step 210, the microphone transmitter 104 transmits a first signal 122 to the wireless microphone receiver 102. The first signal 122 may be, e.g., a control signal, a feedback signal, a reference signal, etc., which is used by the microphone receiver 102 to determine any miss-synchronization in the timing used by the microphone transmitter 104. The microphone receiver 102 receives the first signal 122 in step 212. Further in step 212 the microphone receiver 102, using the first signal 122, determines a symbol timing adjustment for wireless microphone transmitter 104 to synchronize to a target symbol receive time to which multiple wireless microphone transmitters, e.g., microphone transmitters 106, 108, . . . 112, are to be synchronized. Such a timing adjustment is desired for one or more wireless microphone transmitters in the system so that the symbols transmitted by the multiple wireless microphone transmitters communicating with the microphone receiver 102 are received at the microphone receiver 102 in a synchronized manner.

In step 214 the microphone receiver 102 unicasts a first closed loop symbol timing control signal 132 to the wireless microphone transmitter 104. The first closed loop symbol timing control signal 132 controls the symbol timing of the wireless microphone transmitter 104. In some embodiments the first closed loop symbol timing control signal 132 instructs the wireless microphone transmitter 104 to perform one of: advance its symbol timing by an amount which is less than a duration of a symbol time, delay its symbol timing, or make no change in its symbol timing. In step 216 the microphone transmitter 104 receives the first closed loop timing control signal 132 and performs a symbol timing adjustment to adjust its symbol timing in accordance with the received closed loop timing signal 132.

The wireless microphone receiver 102 may also participate in closed loop timing control of other wireless microphone transmitters, e.g., wireless microphone transmitter N 112, in the system as illustrated in FIG. 2 in steps 220, 222, 224 and 226 using dashed arrows. The signaling shown using dashed arrows and the steps corresponding to the signals are optional. Processing performed in steps 220, 222, 224 and 226 is similar to steps 210, 212, 214 and 216, but as can be appreciated from the figure, the exchange of signaling is between the microphone receiver 102 and the microphone transmitter N 112. In step 220, the microphone transmitter N 112 transmits a second signal 128 to the wireless microphone receiver 102. The microphone receiver 102 receives the second signal 128 in step 222. Further in step 222 the microphone receiver 102, using the second signal 128, determines a symbol timing adjustment for wireless microphone transmitter N 112 to synchronize to a target symbol receive time to which multiple wireless microphone transmitters, e.g., microphone transmitters 104, 108, . . . 112, are to be synchronized.

In step 224 the microphone receiver 102 unicasts a second closed loop symbol timing control signal 138 to the wireless microphone transmitter N 112, the second closed loop symbol timing control signal 138 controlling the symbol timing of the wireless microphone transmitter N 112. In some embodiments the second closed loop symbol timing control signal 138 instructs the wireless microphone transmitter N 112 to perform one of: advance its symbol timing by an amount which is less than a duration of a symbol time, delay its symbol timing, or make no change in its symbol timing. In step 226 the microphone transmitter N 112 receives the second closed loop timing control signal 138 and performs a symbol timing adjustment to adjust its symbol timing in accordance with the received closed loop timing signal 138.

A change in position of a wireless microphone transmitter, e.g., such as wireless microphone transmitters 104, 106 etc., relative to a microphone receiver which is fixed, e.g., wireless microphone receiver 102, can, and sometimes does, influence the arrival timing of transmitted symbols at the wireless receiver device. As the wireless microphone transmitter 104 travels further from the wireless microphone receiver 102, the increase in distance may, e.g., cause delay in signals from the wireless microphone transmitter 104 to the wireless microphone receiver 102.

To counter the effect of changing distance between the wireless microphone transmitter and microphone receiver 102 due to a change in position of microphone transmitter device due to motion of the wireless transmitter device, it may be desirable to perform a symbol timing adjustment, e.g., advance or delay the wireless microphone transmitter's symbol transmit timing.

In one embodiment, the wireless microphone transmitters 104, 106, . . . , 112 include timing control modules designed to perform symbol timing adjustments. In some embodiments the timing corrections/adjustments are based on e.g., information and/or periodic signals, such as timing reference signals and/or other control signals, transmitted to the wireless microphone transmitters from receiver 102 as shown in FIG. 2 example.

In order to eliminate or reduce the interference between OFDM signals from different wireless microphone transmitters, e.g., from wireless microphone transmitters 104, 106, . . . , 112, and interference between adjacent OFDM symbols, the received signals from the wireless microphone transmitters should be synchronized with the receiver symbol timing. Specifically, the receiver symbol window, e.g., sampling window, should be placed such that the signal in the symbol window includes a single OFDM symbol from any given wireless microphone transmitter.

Referring once again to FIG. 1, OFDM symbols transmitted from different wireless microphone transmitters 104, 106, . . . , 112, arrive additively at the wireless microphone receiver 102. In some embodiments the wireless microphone receiver 102 includes a receiver circuitry which uses a symbol window to select a portion of a received signal as corresponding to an OFDM symbol. The wireless microphone receiver 102's receiver circuitry then carries out one or more operations on the symbol portion to obtain information, transmitted from the individual wireless microphone transmitters 104, 106, . . . , 112, to the wireless microphone receiver 102. Receiver symbol timing determines where to place the symbol window.

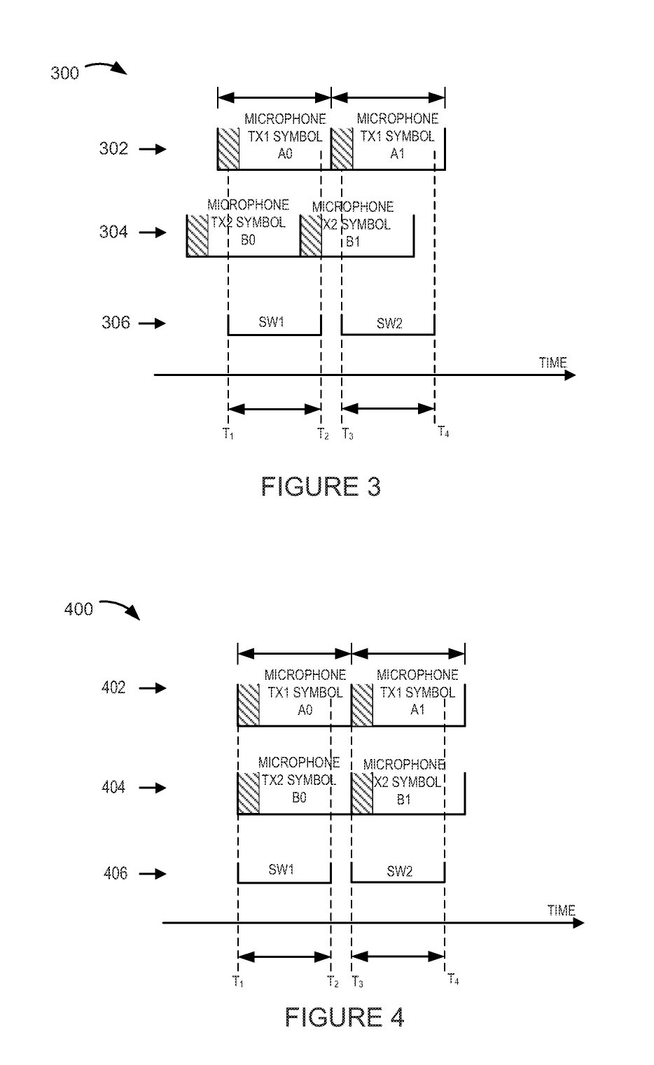

Received OFDM signals from different wireless microphone transmitters 104, 106, . . . , 112 may not always be aligned with each other and the receiver's symbol window resulting in the possible loss of symbol data. FIG. 3 illustrates a timing diagram 300 where exemplary OFDM signals received at the microphone receiver 102 from two wireless microphone transmitters 104, 106 are not synchronized with the microphone receiver 102's symbol timing.

Row 302 illustrates two sequential OFDM symbols A0, A1 transmitted by the wireless microphone transmitter 104. Row 304 illustrates two sequential symbols B0, B1 transmitted by the wireless microphone transmitter 106. Row 306 illustrates two consecutive microphone receiver symbol windows SW1, SW2 which correspond to the time period during which transmitted symbol data is selected to be treated as a received symbol by the wireless microphone receiver 102. The first symbol window SW1 extends from time T1 to time T2, while the second window SW2 extends from time T3 to T4. There is a period between symbol windows SW1, SW2 corresponding to the time between T2 and T3 in which received symbol data is not used. In some embodiments this time period is equal to or smaller than the cyclic prefix of the transmitted symbols. The exemplary symbol window timing shown in FIG. 3 results in symbols from the wireless microphone transmitter 104 to be received properly. However, due to differences in symbol timing between the wireless microphone transmitter 106 and the microphone receiver 102, symbols from the microphone transmitter 106 will not be detected properly.

In the exemplary system 100, OFDM symbols comprise two parts, a cyclic prefix and a body. The shaded portion of the two consecutive OFDM symbols shown in FIG. 3 example represents a cyclic prefix. For example, the shaded portion of OFDM symbol A0 represents the cyclic prefix of the OFDM symbol A0, while shaded portion of OFDM symbol A1 represents the cyclic prefix of the OFDM symbol A1. An OFDM symbol, such as A0, includes a total of, e.g., N samples. The cyclic prefix may include K samples while the body may include N-K samples. The K samples included in the cyclic prefix are obtained by copying the last K samples of the body portion of the OFDM symbol A0, and positioning them in front of the body portion of the symbol A0 which is to be transmitted. Thus, a symbol's cyclic prefix is normally a copy of the last portion of the body. In the example of FIG. 3, the symbols from TX 1 are not precisely aligned with the receiver timing; however, a large enough portion of symbol A0 falls within SW1 and a large enough portion of A1 falls within SW2, respectively, and due to the redundancy included in the cyclic prefix, this allows for successful recovery of the information communicated by A0 and A1 by the wireless microphone receiver. However, in the example, of FIG. 3, the symbols from TX 2 are miss-aligned with the receiver timing above an acceptable level to allow successful recovery. The synchronization error in this case exceeds the width of the cyclic prefix.

FIG. 4 is a timing diagram 400 that illustrates a scenario where the received signals from two wireless microphone transmitters 104, 106 are precisely synchronized with the wireless microphone receiver's symbol timing. Row 402 illustrates two sequential symbols A0, A1 transmitted by the wireless microphone transmitter 104, and row 404 illustrates two sequential symbols B0, B1 transmitted by the wireless microphone transmitter 106. Row 406 illustrates two consecutive base station receiver symbol windows SW1, SW2 which correspond to the time period during which transmitted symbol data is selected to be treated as a received symbol. When receiver symbol timing is properly aligned with the transmitter symbol timing, windows SW1 and SW2 will correspond to the transmitted symbols A0, B1 and A1, B1 as shown in FIG. 4, facilitating successful recovery of the transmitted symbols.

In some embodiments the wireless microphone receiver 102 uses fixed symbol timing. In accordance with one feature of various embodiments, each wireless microphone transmitter communicating with the wireless microphone receiver 102 individually controls its transmitter to adjusts the symbol transmit timing, e.g., in accordance with an individual closed loop symbol timing signal received from the microphone receiver 102, so that the received symbols from each of the wireless microphone transmitters are synchronized with the microphone receiver symbol timing, e.g., to within an acceptable tolerance.

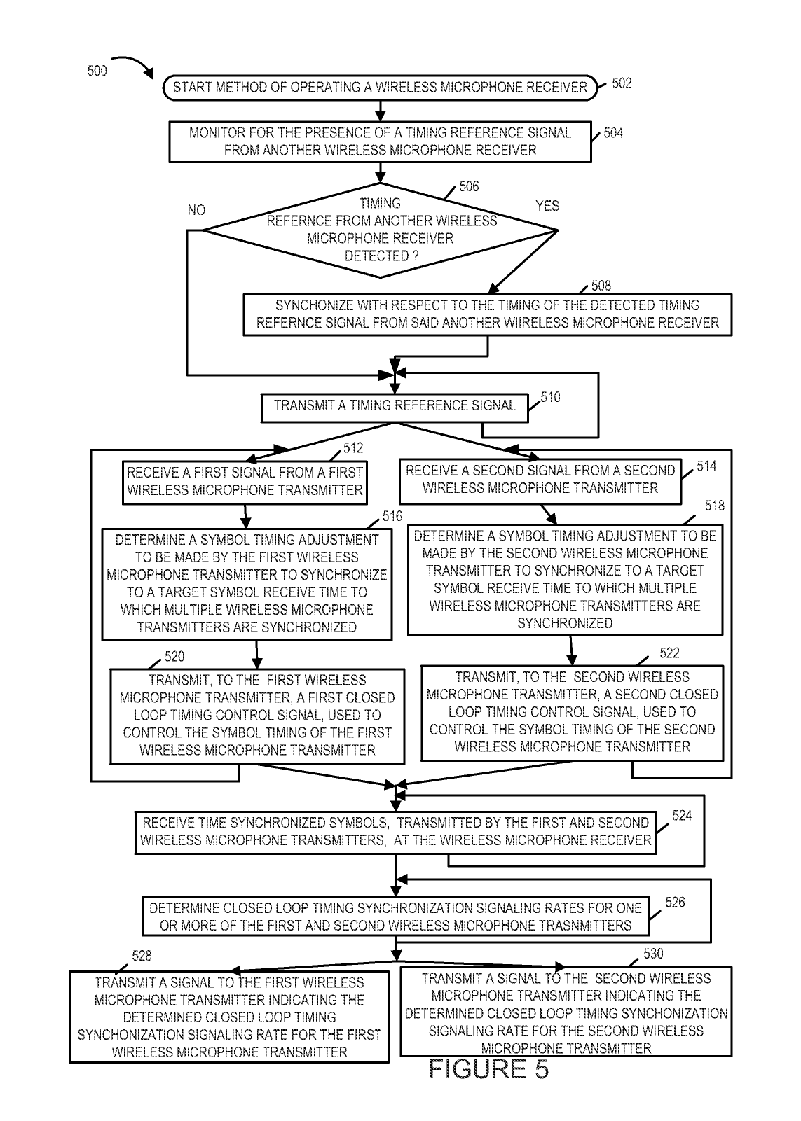

FIG. 5 illustrates a flowchart 500 of an exemplary method of operating a wireless microphone receiver, in accordance with an exemplary embodiment. The wireless microphone receiver implementing the method of flowchart 500 is, e.g., wireless microphone receiver 102 of system 100 of FIG. 1. As will be discussed, in accordance with one feature of various embodiments, the wireless microphone receiver 102 participates in open and closed loop timing control of wireless microphone transmitters 104, 106, . . . , 112 which communicate with wireless microphone receiver 102.

The method of flowchart 500 shown in FIG. 5 starts in step 502, with the wireless microphone receiver 102 being powered on and initialized. Operation proceeds from start step 502 to step 504. In step 504 the wireless microphone receiver, e.g., device 102, monitors for the presence of a timing reference signal from another wireless microphone receiver, e.g., wireless microphone receiver 2 103 of system 100 of FIG. 1. Operation proceeds from step 504 to step 506. In step 506, if the wireless microphone receiver has detected the presence of a timing reference signal from another wireless microphone receiver in step 504, then operation proceeds from step 506 to step 508; otherwise, operation proceeds from step 506 to step 510. Returning to step 508, in step 508, the wireless microphone receiver synchronizes with respect to the timing of the detected timing reference signal from said another wireless microphone receiver. Thus multiple wireless microphone receivers operating in a local vicinity synchronize target symbol receive time. Operation proceeds from step 508 to step 510.

In step 510 the wireless microphone receiver transmits, e.g., broadcasts, a timing reference signal, e.g., signal 120. The timing reference signal 120 is received by various microphone devices in the system 100 which are in the broadcast communications range of the wireless microphone receiver 102. The microphone devices, e.g., microphone transmitters 104, 106, . . . , 112 receiving the timing reference signal 120 may derive system timing structure information and/or other information from the received broadcast timing reference signal 120 so that the microphone transmitters 104, 106, . . . , 112 communicating with the microphone receiver 102 may know when to listen, e.g., for control signals, and/or when to transmit to the microphone receiver 102. The timing reference signal 120 may, and in some embodiments is, broadcast periodically. The wireless microphone transmitters 104, 106, . . . 112 perform an open loop timing control process to synchronize with the timing used in the system 100 based on the received timing reference signal 120.

Operation proceeds from step 510 to steps 512 and 514. Steps 512 and 514 may be performed asynchronously in some embodiments. The operation proceeds along two parallel paths corresponding to each of the steps 512 and 514.

In step 512 the wireless microphone receiver 102 receives a first signal 122 from a first wireless microphone transmitter, e.g., microphone transmitter 104. In various embodiments the first signal 122 is, e.g., a control signal, a feedback signal, a reference signal, etc., used by the microphone receiver 102 to determine any miss-synchronization in the timing used by the microphone transmitter 104.

Operation proceeds from step 512 to step 516. In step 516 the wireless microphone receiver 102 determines a symbol timing adjustment to be made by the first wireless microphone transmitter 104 to synchronize to a target symbol receive time to which multiple wireless microphone transmitters, e.g., microphone transmitters 106, 108, . . . 112, are synchronized. Thus the microphone receiver 102, using the first signal 122, determines a symbol timing adjustment for wireless microphone transmitter 104 to synchronize to a target symbol receive time to which other microphone transmitter devices communicating with microphone receiver 102 are synchronized. As discussed earlier briefly, such a timing adjustment is desired for one or more wireless microphone transmitters in the system so that the symbols transmitted by these wireless microphone transmitters are received at the microphone receiver 102 in a synchronized manner. A target receive symbol time is a time, set by the wireless microphone receiver 102, at which the OFDM symbols transmitted by one or more microphone transmitters should be received at the microphone receiver 102.

Operation proceeds from step 516 to step 520. In step 520 the microphone receiver 102 transmits, e.g., unicasts, to the wireless microphone transmitter 104, a first closed loop symbol timing control signal 132 used to control the symbol timing of the first wireless microphone transmitter 104. In some embodiments the first closed loop symbol timing control signal 132 instructs the first wireless microphone transmitter 104 to advance or delay symbol timing. In some embodiments the first closed loop symbol timing control signal 215 instructs the wireless microphone transmitter 104 to perform one of: advance its symbol timing by an amount which is less than a duration of a symbol time, delay its symbol timing, or make no change in its symbol timing. Operation proceeds from step 520 to step 512 and to step 524.

Referring now to the parallel path including steps 514, 518 and 522. In step 514, the wireless microphone receiver 102 receives a second signal, e.g., signal 124, from a second wireless microphone transmitter, e.g., microphone transmitter 106. In various embodiments the second signal 124 is, e.g., a control signal, a feedback signal, a reference signal, etc., used by the microphone receiver 102 to determine any miss-synchronization in the timing used by the second wireless microphone transmitter 106.

Operation proceeds from step 514 to step 518. In step 518 the wireless microphone receiver 102 determines a symbol timing adjustment required by the second wireless microphone transmitter 106 to synchronize to a target symbol receive time to which multiple wireless microphone transmitters, e.g., microphone transmitters 104, 108, . . . 112, are synchronized. Thus the microphone receiver 102, using the second signal 124, determines a symbol timing adjustment for the second wireless microphone transmitter 106, so that the symbols transmitted by the wireless microphone transmitter 106 are received at the microphone receiver 102 in a synchronized manner, i.e., in synch with symbols received from other wireless microphone transmitters communicating with the microphone receiver 102.

Operation proceeds from step 518 to step 522. In step 522 the microphone receiver 102 transmits, e.g., unicasts, to the second wireless microphone transmitter 106, a second closed loop symbol timing control signal 134 used to control the symbol timing of the second wireless microphone transmitter 106. In some embodiments the second closed loop symbol timing control signal 134 instructs the second wireless microphone transmitter 106 to advance or delay symbol timing. In some embodiments the second closed loop symbol timing control signal instructs the wireless microphone transmitter 106 to perform one of: advance its symbol timing by an amount which is less than a duration of a symbol time, delay its symbol timing, or make no change in its symbol timing. In various embodiments the first and second closed loop symbol timing control signals are transmitted over a control channel, said control channel using a first frequency band which is different from a second frequency band used for the communication of audio signals. The operation proceeds from step 522 to step 514 and to step 524.

In step 524, which is performed on an ongoing basis, the wireless microphone receiver 102 receives, time synchronized symbols, transmitted by the first and second wireless microphone transmitters 104, 106. Operation proceeds from step 524 to step 526. In step 526, which is performed on an ongoing basis, the wireless microphone receiver determines closed loop timing synchronization signaling rates for one or more of the first and second wireless microphone transmitters. Operation proceeds from step 526 to step 528 and step 530. In step 528, the wireless microphone receiver 102 transmits a signal to the first wireless microphone transmitter 104 indicating the determined closed loop timing synchronization signaling rate for the first wireless microphone transmitter 104. In step 530, the wireless microphone receiver 102 transmits a signal to the second wireless microphone transmitter 106 indicating the determined closed loop timing synchronization signaling rate for the second wireless microphone transmitter 106. The determined closed loop timing synchronization signaling rates for the first and second wireless microphone transmitters may be, and sometimes are, different. The determined closed loop timing synchronization signaling rate for the first wireless microphone receiver controls the repeat rate of the loop including steps 512, 516 and 520. The determined closed loop timing synchronization signaling rate for the second wireless microphone receiver controls the repeat rate of the loop including steps 514, 518 and 522. Over time, as conditions change, e.g., due to wireless microphone transmitter device motion and/or position and/or device oscillator drift and/or instability, the determined closed loop timing synchronization rate for a particular wireless microphone transmitter may, and sometimes does change.

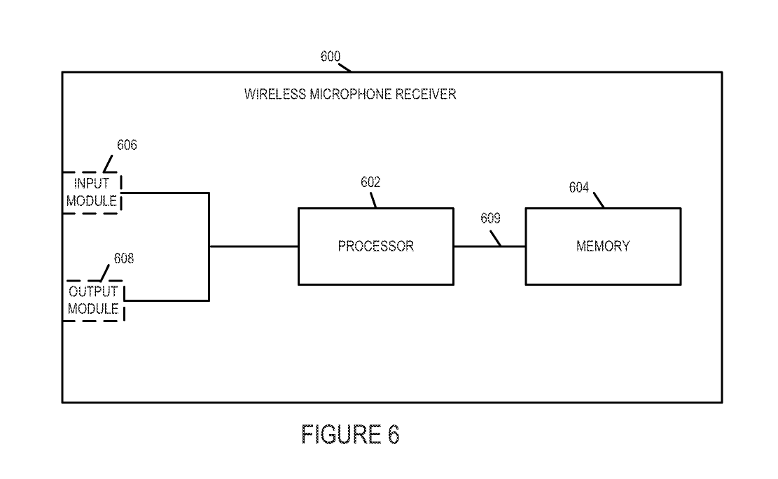

FIG. 6 is a drawing of an exemplary wireless microphone receiver device 600, in accordance with an exemplary embodiment. Exemplary wireless microphone receiver 600 may be used as the wireless microphone receiver 102 of FIG. 1 Exemplary wireless microphone receiver 600 may, and sometimes does, implement a method in accordance with flowchart 500 of FIG. 5.

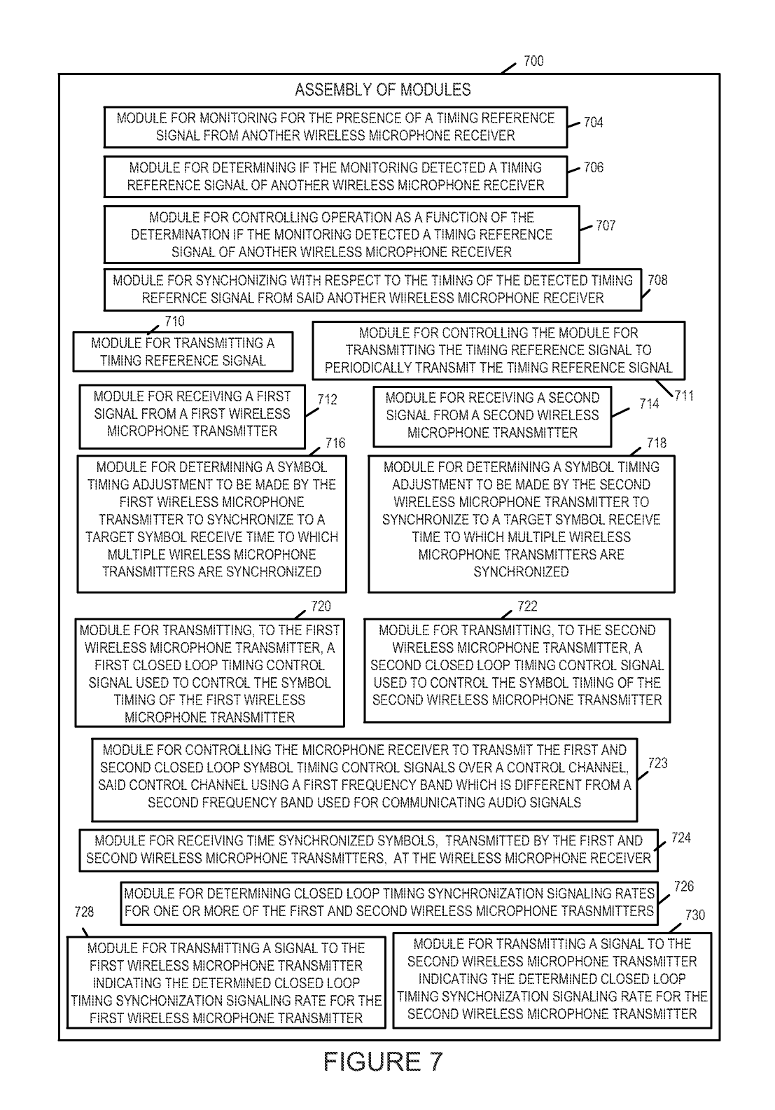

The wireless microphone receiver 600 includes a processor 602 and memory 604 coupled together via a bus 609 over which the various elements (602, 604) may interchange data and information. The memory 604 may include an assembly of modules used to control the wireless microphone receiver 600, e.g., such as the assembly of modules shown in FIG. 7. The wireless microphone receiver 600 further includes an input module 606 and an output module 608 which may be coupled to processor 602 as shown. However, in some embodiments, the input module 606 and output module 608 are located internal to the processor 602. Input module 606 can receive input signals. Input module 606 can, and in some embodiments does, include a wireless receiver and/or a wired or optical input interface for receiving input. Output module 608 may include, and in some embodiments does include, a wireless transmitter and/or a wired or optical output interface for transmitting output.

In various embodiments, processor 602 is configured to transmit, e.g., broadcast, a timing reference signal, receive a first signal from a first wireless microphone transmitter 104, and transmit, e.g., unicast, to the wireless microphone transmitter 104, a first closed loop symbol timing control signal used to control the symbol timing of the first wireless microphone transmitter 104. In some embodiments the processor 602 is configured to broadcast the timing reference signal periodically, e.g., at regular intervals. In some embodiments the first closed loop symbol timing control signal instructs the first wireless microphone transmitter 104 to advance or delay symbol timing. In some embodiments the first closed loop symbol timing control signal 132 instructs the wireless microphone transmitter 104 to perform one of: advance its symbol timing by an amount which is less than a duration of a symbol time, delay its symbol timing, or make no change in its symbol timing.

In various embodiments the processor 602 is further configured to determine, prior to transmitting the first closed loop symbol timing control signal to the first wireless microphone transmitter 104, a symbol timing adjustment to be made by the first wireless microphone transmitter 104 to synchronize to a target symbol receive time to which multiple wireless microphone transmitters, e.g., microphone transmitters 106, 108, . . . 112, are synchronized. It should be appreciated that said multiple wireless microphone transmitters are also communicating with the microphone receiver 102.

In some embodiments the processor 602 is further configured to receive a second signal from a second wireless microphone transmitter 106, determine a symbol timing adjustment to be made by the second wireless microphone transmitter 106 to synchronize to a target symbol receive time to which multiple wireless microphone transmitters, e.g., microphone transmitters 104, 108, . . . 112, are synchronized, and transmit, e.g., unicast, to the second wireless microphone transmitter 106, a second closed loop symbol timing control signal used to control the symbol timing of the second wireless microphone transmitter 106. In some embodiments the second closed loop symbol timing control signal instructs the second wireless microphone transmitter 106 to advance or delay its symbol timing. In some embodiments, the second closed loop symbol timing control signal instructs the second wireless microphone transmitter 106 to perform one of: advance its symbol timing by an amount which is less than a duration of a symbol time, delay its symbol timing, or make no change in its symbol timing.

In some embodiments, the processor 602 is configured to transmit the first and second closed loop symbol timing control signals over a control channel, said control channel using a first frequency band which is different from a second frequency band used for the communication of audio signals.

In some embodiments, processor 602 is configured to monitor for the presence of a timing reference signal from another wireless microphone receiver, and control operation as a function of the determination as to whether or not a timing reference signal was detected from another wireless microphone receiver. In some such embodiments, processor 602 is configured to synchronize with respect to the timing of the detected reference signal from said another wireless microphone receiver in response to detecting the presence of a timing reference signal from said another wireless microphone receiver.

In various embodiments, processor 602 is further configured to receive time synchronized symbols, transmitted by the first and second wireless microphone transmitters, at the wireless microphone receiver. In some embodiments, processor 602 is further configured to determine closed loop timing synchronization rates for one or more of the first and second wireless microphone transmitters. In some such embodiments, processor 602 is configured to transmit a signal to the first wireless microphone transmitter indicating the determined closed loop timing synchronization signaling rate for the first wireless microphone transmitter and transmit a signal to the second wireless microphone transmitter indicating the determined closed loop timing synchronization signaling rate for the second wireless microphone transmitter. The determined closed loop timing synchronization signaling rate for the first wireless microphone transmitter may be, and sometimes is, different from the determined closed loop timing synchronization signaling rate for the second wireless microphone transmitter.

FIG. 7 illustrates an assembly of modules 700 which can, and in some embodiments is, used in a wireless microphone receiver such as the wireless microphone receiver 600 illustrated in FIG. 6 or the wireless microphone receiver 102 illustrated in FIGS. 1 and 2. The modules in the assembly 700 can be implemented in hardware within the processor 602 of FIG. 6, e.g., as individual circuits. Alternatively, the modules may be implemented in software and stored in the memory 604 of the wireless microphone receiver 600 shown in FIG. 6. While shown in the FIG. 6 embodiment as a single processor, e.g., computer, it should be appreciated that the processor 602 may be implemented as one or more processors, e.g., computers.

When implemented in software the modules include code, which when executed by the processor, configure the processor, e.g., computer, 602 to implement the function corresponding to the module. In some embodiments, processor 602 is configured to implement each of the modules of the assembly of modules 700. In embodiments where the assembly of modules 700 is stored in the memory 604, the memory 604 is a computer program product comprising a computer readable medium comprising code, e.g., individual code for each module, for causing at least one computer, e.g., processor 602, to implement the functions to which the modules correspond.

Completely hardware based or completely software based modules may be used. However, it should be appreciated that any combination of software and hardware (e.g., circuit implemented) modules may be used to implement the functions. As should be appreciated, the modules illustrated in FIG. 7 control and/or configure the wireless microphone receiver 600 or elements therein such as the processor 602, to perform the functions of the corresponding steps illustrated and/or described in the method of flowchart 500 of FIG. 5.

The assembly of modules 700 includes a module corresponding to each step of the method of flowchart 500 shown in FIG. 5. For example module 704 corresponds to step 504 and is responsible for performing the operation described with regard to step 504.

Assembly of modules 700 includes a module 704 for monitoring for the presence of a timing reference signal from another wireless microphone receiver, a module 606 for determining if the monitoring of module 704 detected a timing reference signal of another wireless microphone receiver, a module 707 for controlling operation as a function of the determination if the monitoring detected a timing reference signal of another wireless microphone receiver, and a module 708 for synchronizing with respect to the timing of the detected timing reference signal from said another wireless microphone receiver.

The assembly of modules 700 further includes a module 710 for transmitting, e.g., broadcasting, a timing reference signal, a module 711 for controlling the module for transmitting 710 to broadcast the timing reference signal periodically, a module 712 for receiving a first signal from a first wireless microphone transmitter 104, and a module 714 for receiving a second signal from a second wireless microphone transmitter 106.

The assembly of modules 700 further includes a module 716 for determining symbol timing adjustment to be made by the first wireless microphone transmitter 104 to synchronize to a target symbol receive time to which multiple wireless microphone transmitters are synchronized, and a module 718 for determining symbol timing adjustment to be made by the second wireless microphone transmitter 106 to synchronize to a target symbol receive time to which multiple wireless microphone transmitters are synchronized.

The assembly of modules 700 further includes a module 720 for transmitting, to the first wireless microphone transmitter 104, a first closed loop symbol timing control signal 132 used to control the symbol timing of the first wireless microphone transmitter 104, and a module 722 for transmitting, to the second wireless microphone transmitter 106, a second closed loop symbol timing control signal 134 used to control the symbol timing of the second wireless microphone transmitter 106.

In some embodiments the first closed loop symbol timing control signal instructs the first wireless microphone transmitter 104 to advance or delay symbol timing. In some embodiments the first closed loop symbol timing control signal 132 instructs the wireless microphone transmitter 104 to perform one of: advance its symbol timing by an amount which is less than a duration of a symbol time, delay its symbol timing, or make no change in its symbol timing. In some embodiments the second closed loop symbol timing control signal 134 instructs the second wireless microphone transmitter 106 to advance or delay symbol timing. In some embodiments the second closed loop symbol timing control signal 134 instructs the wireless microphone transmitter 106 to perform one of: advance its symbol timing by an amount which is less than a duration of a symbol time, delay its symbol timing, or make no change in its symbol timing.

In some embodiments, the assembly of modules 700 further includes a module 723 for controlling the wireless microphone receiver 600 to transmit the first and second closed loop symbol timing control signals over a control channel, said control channel using a first frequency band which is different from a second frequency band used for the communication of audio signals. The assembly of modules 700 further includes a module 724 for receiving time synchronized symbols transmitted by the first and second wireless microphone transmitters (104, 106) at the wireless microphone receiver.

Assembly of modules 700 further includes a module 726 for determining closed loop timing synchronization signaling rates for one or more of the first and second wireless microphone transmitters, a module 728 for transmitting a signal to the first wireless microphone transmitter indicating the determined closed loop timing synchronization rate for the first wireless microphone transmitter and a module 730 for transmitting a signal to the second wireless microphone transmitter 106 indicating the determined closed loop timing synchronization rate for the second wireless microphone transmitter.

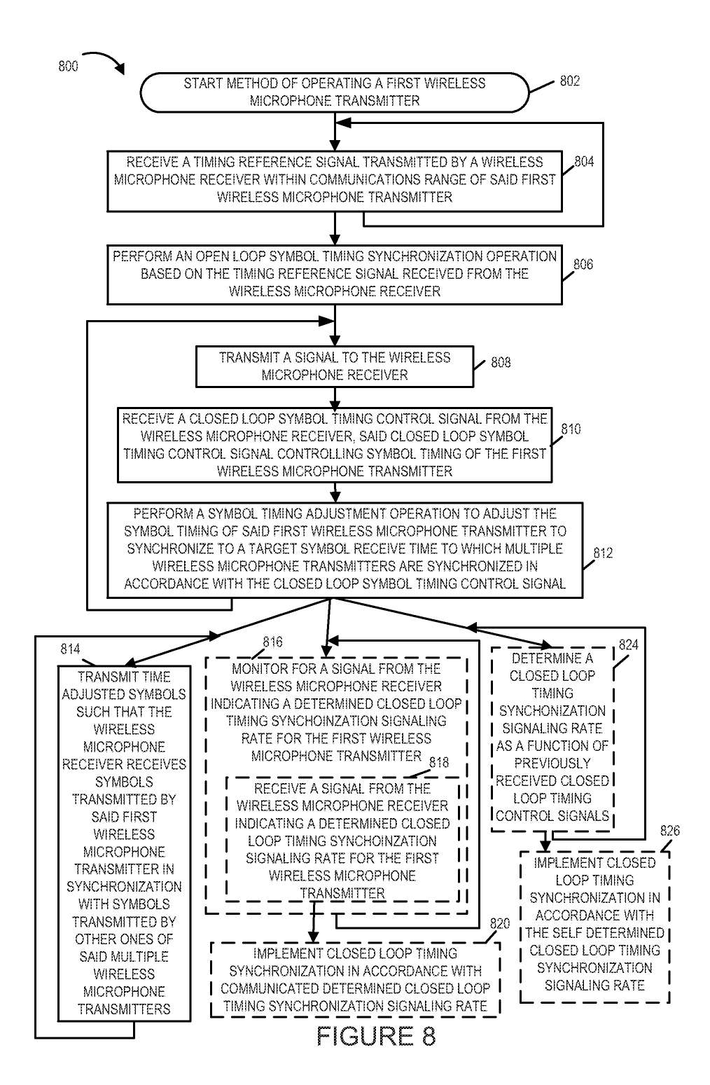

FIG. 8 illustrates a flowchart 800 of an exemplary method of operating a first wireless microphone transmitter, in accordance with an exemplary embodiment. The wireless microphone transmitter implementing the method of flowchart 800 can be any one of the wireless microphone transmitters 104, 106, 108, . . . , 112 of system 100 of FIG. 1. For the purpose of discussion, consider that the first wireless microphone transmitter implementing the exemplary method of flowchart 800 is the wireless microphone transmitter 104 of exemplary system 100 of FIG. 1. As will be discussed, in accordance with one feature of various embodiments, the first wireless microphone transmitter 104 communicates with the microphone receiver 102 to achieve timing synchronization and interference management.

The method of flowchart 800 shown in FIG. 8 starts in step 802, where the wireless microphone transmitter 104 is powered on and initialized. Operation proceeds from start step 802 to step 804.

In step 804 the first wireless microphone transmitter 104 receives a timing reference signal transmitted by a wireless microphone receiver 102 within communications range of the first wireless microphone transmitter 104. As discussed with regard to FIG. 5 example, the microphone receiver 102 broadcasts such a timing reference signal 120. The wireless microphone transmitters in the system including the first microphone transmitter 104 receive the timing reference signal 120 and use it, e.g., to synchronize with the timing used by the microphone receiver 102. In some embodiments the timing reference signal is periodically received by the first wireless microphone transmitter 104, e.g., on an ongoing basis.

Operation proceeds from step 804 to step 806. In step 806 the first wireless microphone transmitter 104 performs an open loop timing synchronization operation based on the timing reference signal 120 received from the wireless microphone receiver 102. In the open loop timing control process the first wireless microphone transmitter 104 derives system timing structure information and/or other information from the received broadcast timing reference signal 120. Thus in the open loop timing control operation, using the timing reference signal 120, the wireless microphone transmitter 104 derives a basic timing reference point in order to be able to determine when to listen, e.g., monitor for control signals, and when to transmit to the wireless microphone receiver 102 in the system 100.

Operation proceeds from step 806 to step 808. In step 808 the wireless microphone transmitter 104 transmits a signal, e.g., signal 122, to the wireless microphone receiver 102. Operation proceeds from step 808 to step 810. In step 810 the first wireless microphone transmitter 104 receives a closed loop symbol timing control signal from the microphone receiver 102, said closed loop symbol timing control signal controlling the symbol timing of the first wireless microphone transmitter 104. In some embodiments the closed loop symbol timing control signal instructs the wireless microphone transmitter 104 to advance or delay the symbol timing of the first wireless microphone transmitter 104. In some embodiments the closed loop symbol timing control signal instructs the wireless microphone transmitter 104 to perform one of: advance symbol timing by an amount which is less than a duration of a symbol time, delay symbol timing, or make no change in symbol timing. In some embodiments the closed loop timing control signal is received over a control channel, said control channel using a first frequency band which is different from a second frequency band used for the communication of audio signals.

Operation proceeds from step 810 to step 812. In step 812 the first wireless microphone transmitter 104 performs, in accordance with the closed loop symbol timing control signal, a symbol timing adjustment operation to adjust the symbol timing of said first wireless microphone transmitter to synchronize to a target symbol receive time to which multiple wireless microphone transmitters are synchronized in accordance with the closed loop symbol timing control signal. In some embodiments a transmitter circuit of the first wireless microphone transmitter 104 is controlled to perform a symbol time adjustment in accordance with the closed loop symbol timing control signal. Thus the wireless microphone transmitter performs symbol timing adjustment as instructed in the closed loop symbol timing control signal so that the symbols transmitted by first microphone transmitter 104 are received at the microphone receiver 102 in a synchronized manner with symbols transmitted by other various wireless microphone transmitters, e.g., 106, 108, . . . , 112 communicating with the wireless microphone receiver 102.

Operation proceeds from step 812 to step 808 and step 814. Operation also proceeds from step 812 to one of optional step 816 and optional step 824. In step 814, which is performed on an ongoing basis, the first wireless microphone transmitter 104 transmits time adjusted symbols such that the microphone receiver 102 receives the time adjusted symbols transmitted by the first wireless microphone transmitter 104 synchronized with symbols transmitted by other ones of said multiple wireless microphone transmitters, e.g., 106, 106, . . . , 112 communicating with the microphone receiver 102. At least some of the time adjusted symbols communicate audio data, e.g., audio traffic data. Steps 816 and 820 are performed in some embodiments, in which the wireless microphone receiver determines a closed loop timing synchronization signaling rate for the first wireless microphone transmitter. Steps 824 and 826 are performed in some embodiments, in which the first wireless microphone transmitter self-determines its closed loop timing synchronization signaling rate.

Returning to step 816, in step 816, which is performed on an ongoing basis, the first wireless microphone transmitter monitors for a signal from the wireless microphone receiver indicating a determined closed loop timing synchronization signaling rate for the first wireless microphone transmitter. Step 816 may, and sometimes does include step 818 in which the first wireless microphone transmitter receives a signal from the wireless microphone receiver indicating a determined closed loop timing synchronization signaling rate for the first wireless microphone transmitter. Operation proceeds from step 818 to step 820, in which the first wireless microphone transmitter implements closed loop timing synchronization in accordance with the communicated determined closed loop timing synchronization signaling rate.

Returning to step 824 in step 824, which is performed on an ongoing basis, the first wireless microphone transmitter determines a closed loop timing synchronization signaling rate for the first wireless microphone transmitter as a function of previously received closed loop timing controls signals. For example, if the wireless microphone transmitter has been previously receiving very few timing synchronization correction commands and/or very small corrections, the wireless microphone transmitter may decide to perform closed loop timing synchronization signaling less frequently. Alternatively, if the wireless microphone transmitter has been previously receiving many timing synchronization correction commands and/or very large corrections, the wireless microphone transmitter may decide to perform closed loop timing synchronization signaling more frequently.

Operation proceeds from step 824 to step 826 in which the first wireless microphone transmitter implements closed loop timing synchronization in accordance with the self-determined closed loop timing synchronization signaling rate of step 824.

Implementing closed loop timing synchronization in accordance with the communicated determined closed loop timing synchronization signaling rate or implementing closed loop timing synchronization in accordance with the self-determined closed loop timing synchronization signaling rate includes performing the iteration of steps 808, 810 and 812 in accordance with the signaling rate. In various embodiments, the first wireless microphone transmitter starts operation initially at a default closed loop timing synchronization signaling rate and may, and sometimes does, change to a different closed loop timing synchronization signaling rate in response to current conditions. In some embodiments, different signaling rates correspond to using different sets of air link resources in the control channel, e.g., different predetermined sets of air link resources in the control channel.

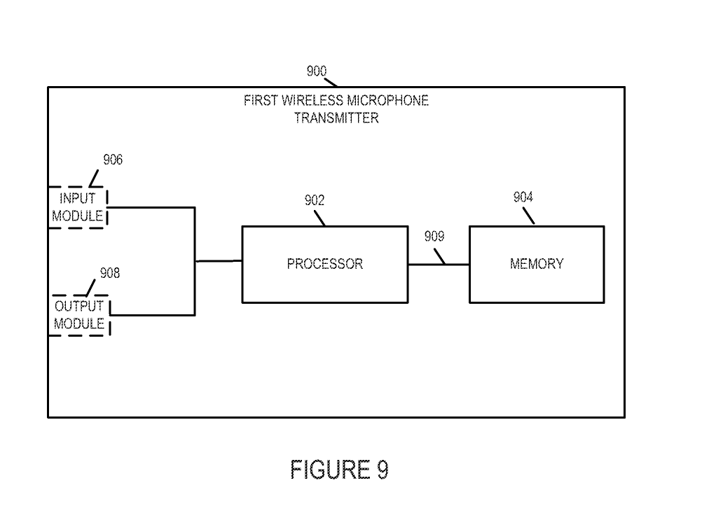

FIG. 9 is a drawing of an exemplary first wireless microphone transmitter 900, in accordance with an exemplary embodiment. Exemplary first wireless microphone transmitter 900 may be used as any one of the wireless microphone transmitters shown in FIG. 1. Exemplary first wireless microphone transmitter 900 may, and sometimes does, implement a method in accordance with flowchart 800 of FIG. 8.

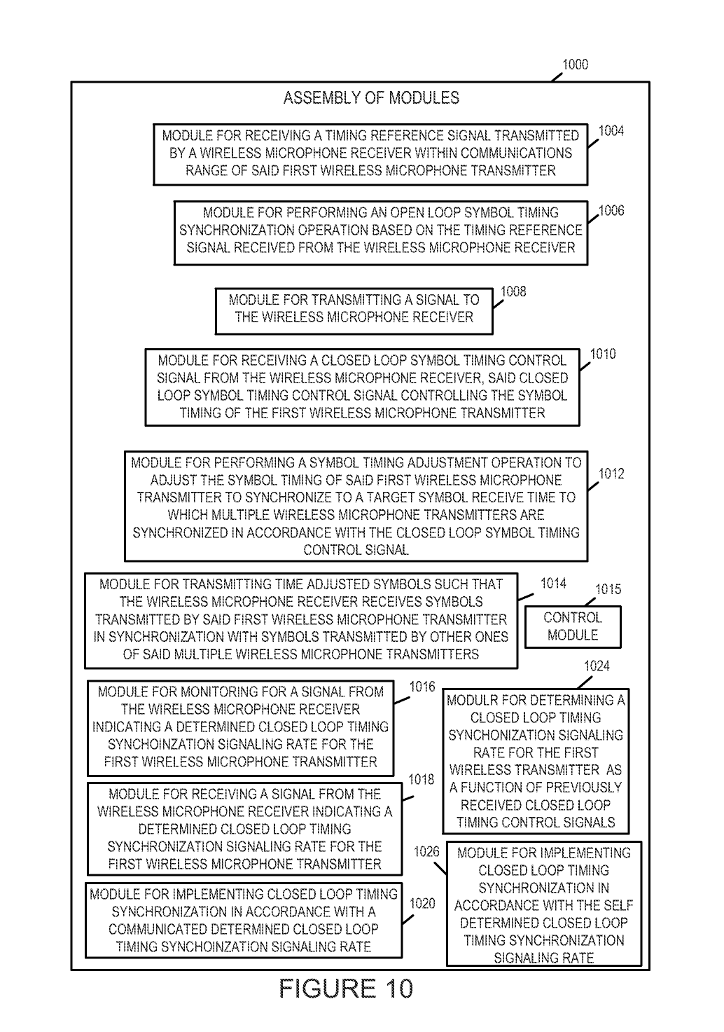

The first wireless microphone transmitter 900 includes a processor 902 and memory 904 coupled together via a bus 909 over which the various elements (902, 904) may interchange data and information. The memory 904 may include an assembly of modules used to control the first wireless microphone transmitter 900, e.g., such as the assembly of modules shown in FIG. 10. The wireless microphone transmitter 900 further includes an input module 906 and an output module 908 which may be coupled to processor 902 as shown. However, in some embodiments, the input module 906 and output module 908 are located internal to the processor 902. Input module 906 can receive input signals. Input module 906 can, and in some embodiments does, include a wireless receiver and/or a wired or optical input interface for receiving input. Output module 908 may include, and in some embodiments does include, a wireless transmitter and/or a wired or optical output interface for transmitting output.

In various embodiments, processor 902 is configured to receive a timing reference signal transmitted by a wireless microphone receiver 102 within communications range of the first wireless microphone transmitter 900, transmit a signal, e.g., signal 122, to the wireless microphone receiver 102, and receive a closed loop symbol timing control signal from the microphone receiver 102, said closed loop symbol timing control signal controlling the symbol timing of the first wireless microphone transmitter 900. In some embodiments the timing reference signal is periodically received by the first wireless microphone transmitter 900.

In some embodiments the closed loop symbol timing control signal instructs the processor 902 to advance or delay the symbol timing of the first wireless microphone transmitter 900. In some embodiments the closed loop symbol timing control signal instructs the processor 902 to perform one of: advance symbol timing by an amount which is less than a duration of a symbol time, delay symbol timing, or make no change in symbol timing. In some embodiments the closed loop timing control signal is received over a control channel, said control channel using a first frequency band which is different from a second frequency band used for the communication of audio signals. In some embodiments, the first frequency band used for conveying control channel information is intentionally a higher frequency band than the second frequency band used for conveying audio channel data.

In various embodiments the processor 902 is further configured to perform an open loop timing synchronization operation based on the timing reference signal 120 received from the wireless microphone receiver 102. In some such embodiments the processor 902 is configured to derive system timing structure information and/or other information from the received broadcast timing reference signal 120.

In various embodiments the processor 902 is further configured to perform, in accordance with the closed loop symbol timing control signal, a symbol timing adjustment operation to adjust the symbol timing of said first wireless microphone transmitter 900 to synchronize to a target symbol receive time to which multiple wireless microphone transmitters are synchronized.

Processor 902 in some embodiments is further configured to transmit time adjusted symbols to the microphone receiver 102. In accordance with one aspect, the symbol timing adjustment is performed in a manner so that the microphone receiver 102 receives the time adjusted symbols transmitted by the first wireless microphone transmitter 900 in a synchronized manner with symbols transmitted by the multiple wireless microphone transmitters, e.g., 106, 106, . . . , 112 communicating with the microphone receiver 102.

Processor 902, in various embodiments, is further configured to: monitor for a signal from the wireless microphone receiver 102 indicating a determined closed loop timing synchronization signaling rate for the first wireless microphone transmitter 900 and to receive a signal from the wireless microphone receiver 102 indicating a determined closed loop timing synchronization signaling rate for the first wireless microphone transmitter. In some such embodiments, processor 902 is further configured to implement closed loop timing synchronization in accordance with the communicated determined closed loop timing synchronization signaling rate in response to a received signal from the wireless microphone receiver indicating a determined closed link timing synchronization signaling rate for the first wireless microphone transmitter.

In some embodiments, processor 902 is configured to determine a closed loop timing synchronization signaling rate as a function of previously received closed loop timing control signals and to implement closed loop timing synchronization in accordance with the self-determined closed loop timing synchronization signaling rate.

FIG. 10 illustrates an assembly of modules 1000 which can, and in some embodiments is, used in a wireless microphone transmitter such as the first wireless microphone transmitter 900 illustrated in FIG. 9. The modules in the assembly 1000 can be implemented in hardware within the processor 902 of FIG. 9, e.g., as individual circuits. Alternatively, the modules may be implemented in software and stored in the memory 904 of the wireless microphone transmitter 900 shown in FIG. 9. While shown in the FIG. 9 embodiment as a single processor, e.g., computer, it should be appreciated that the processor 902 may be implemented as one or more processors, e.g., computers.

When implemented in software the modules include code, which when executed by the processor, configure the processor, e.g., computer, 902 to implement the function corresponding to the module. In some embodiments, processor 902 is configured to implement each of the modules of the assembly of modules 1000. In embodiments where the assembly of modules 1000 is stored in the memory 904, the memory 904 is a computer program product comprising a computer readable medium comprising code, e.g., individual code for each module, for causing at least one computer, e.g., processor 902, to implement the functions to which the modules correspond.

Completely hardware based or completely software based modules may be used. However, it should be appreciated that any combination of software and hardware (e.g., circuit implemented) modules may be used to implement the functions. As should be appreciated, the modules illustrated in FIG. 10 control and/or configure the first wireless microphone transmitter 900 or elements therein such as the processor 902, to perform the functions of the corresponding steps illustrated and/or described in the method of flowchart 800 of FIG. 8.

The assembly of modules 1000 includes a module corresponding to each step of the method of flowchart 800 shown in FIG. 8. For example module 1004 corresponds to step 804 and is responsible for performing the operation described with regard to step 804. The assembly of modules 1000 includes a module 1004 for receiving a timing reference signal transmitted by a wireless microphone receiver 102 within communications range of the first wireless microphone transmitter 900, a module 1006 for performing an open loop timing synchronization operation based on the timing reference signal received from the wireless microphone receiver 102, a module 1008 for transmitting a signal, e.g., signal 122, to the wireless microphone receiver 102, and a module 1010 for receiving a closed loop symbol timing control signal from the microphone receiver 102, said closed loop symbol timing control signal controlling the symbol timing of the first wireless microphone transmitter 900.

In some embodiments module 1006 for performing open loop timing control process derives system timing structure information and/or other information from the received broadcast timing reference signal 120. In some embodiments the closed loop symbol timing control signal instructs the first wireless microphone transmitter 900 to advance or delay the symbol timing of the first wireless microphone transmitter 900. In some such embodiments the module 1010 recovers the instructions communicated by the closed loop timing signal. In some embodiments the assembly of modules 1000 includes a control module 1015 for controlling the operation of one or more modules shown in the assembly of modules 1000. For example in some embodiments the control module 1015 controls the receiver module 1010 to receive the closed loop timing control signal over a control channel, said control channel using a first frequency band which is different from a second frequency band used for the communication of audio signals. Thus in some embodiments the closed loop timing control signal is received by module 1010 over a control channel which uses a frequency band which is different from another frequency band used for the communication of audio signals.

The assembly of modules 1000 further includes a module 1012 for performing a symbol timing adjustment operation to adjust the symbol timing of said first wireless microphone transmitter 900 to synchronize to a target symbol receive time to which multiple wireless microphone transmitters are synchronized, and module 1014 for transmitting time adjusted symbols such that the microphone receiver 102 receives the time adjusted symbols transmitted by the first wireless microphone transmitter 900 in synchronization with symbols transmitted by other ones of said multiple wireless microphone transmitters communicating with the microphone receiver 102.

Thus in various embodiments, module 1012 performs a symbol time adjustment in accordance with the closed loop symbol timing control signal received from the wireless microphone receiver. In some embodiments the module 1012 performs, in accordance with the received closed loop symbol timing control signal, an advance or delay of the symbol timing of the first wireless microphone transmitter. In some embodiments the module 1012 performs, in accordance with the received closed loop symbol timing control signal, one of the following operation: advance symbol timing by an amount which is less than a duration of a symbol time, delay symbol timing, or make no change in symbol timing.

Assembly of modules 1000 further includes a module 1016 for monitoring for a signal from the wireless microphone receiver indicating a determined closed loop timing synchronization signaling rate for the first wireless microphone transmitter, a module 1018 for receiving a signal from the wireless microphone receiver indicating a determined closed loop timing synchronization signaling rate for the first wireless microphone transmitter, and a module 1020 for implementing closed loop timing synchronization in accordance with a communicated determined closed loop timing synchronization signaling rate. Assembly of modules 1000 further includes a module 1024 for determining a closed loop timing synchronization signaling rate for the first wireless transmitter as a function of previously received closed loop timing control signals and a module 1026 for implementing closed loop timing synchronization in accordance with the self determined closed loop riming synchronization signaling rate.

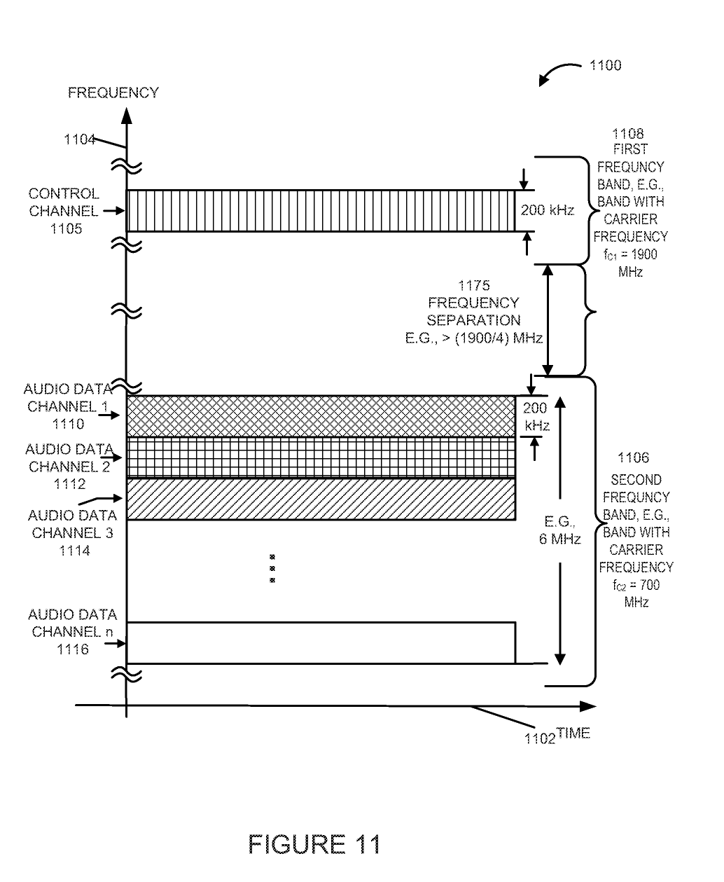

FIG. 11 illustrates an exemplary time frequency structure of exemplary communications channels which can be used for microphone communications, e.g., microphone audio data and control signaling communications, in exemplary wireless microphone communications system 100 of FIG. 1. In drawing 1100 of FIG. 11, the horizontal axis 1102 represents time and the vertical axis 1104 represents frequency. FIG. 11 illustrates an example of frequency division multiplexing (FDM) between control channel and audio traffic channels. The exemplary time frequency structure of drawing 1100 includes a second frequency band 1106 used for audio data channels and a first frequency band 1108 used for the control channel. The first frequency band is, e.g., a frequency band with carrier frequency f_{C1}=1900 MHz. The second frequency band is, e.g., a frequency band with carrier frequency f_{C2}=700 MHz. Frequency band 1106 includes a plurality of communications channels which can be used for wireless microphone communications, e.g., for communicating audio traffic signals from the wireless microphone transmitters to the wireless microphone receiver 102, in accordance with some exemplary embodiments. Frequency band 1106 includes a plurality of audio traffic communications channels including audio data channel 1 1110, audio data channel 2 1112 audio data channel 3 1114, . . . , audio data channel N 1116. In this example each audio data channel is a 200 kHz channel. Signals of the audio data channel may be modulated on the carrier frequency of the second frequency band. In some embodiments, an individual wireless microphone transmitter may acquire and use a single audio data channel. In some embodiments, at least some individual wireless microphone transmitters may, and sometimes do, acquire and use multiple audio data channels.

In the FIG. 11 example, there is a separate control channel 1105 corresponding to a frequency band 1108 which is different than the frequency band 1106 used for audio traffic communications. The frequency band 1106 corresponding to the various audio traffic channels is lower in frequency than the frequency band 1108 corresponding to the control channel 1105. In one embodiment the control channel 1105 is a 200 kHz frequency channel. Signals of the control channel may be modulated on the carrier frequency of the first frequency band. In some embodiments, different portions of the control channel 1105 correspond to different audio data channels. In various embodiments, different non-overlapping time-frequency portions of the control channel correspond to different audio data channels in accordance with a predetermined mapping. In some embodiments, different wireless microphone transmitters may be, and sometimes are, allocated different relative portions of the control channel, e.g., to accommodate different determined closed loop timing synchronization signaling rates. In some embodiments, at different times, the same wireless microphone transmitter may be, and sometimes are, allocated different relative portions of the control channel. The control channel 1105 is used by wireless microphone receiver device 102 in the system for transmitting microphone transmitter control signals, e.g., including closed loop timing synchronization control signals, from the wireless microphone receiver 102 to one or more of the wireless microphone transmitter devices (104, 106, 108, . . . , 112) and for receiving control information, e.g., including closed loop timing synchronization control signals, from one or more wireless microphone transmitters (104, 106, 108, . . . , 112).

Each communications channel may include one or more tones. In one example within frequency band 1106 there are N 200 kHz audio data channels, where N=30, representing a 6 MHz block of channels. In some embodiments each audio data channel includes, e.g., 16 OFDM tones.

It should be appreciated that in some embodiments there is a large frequency separation 1175 between the frequency band 1108 corresponding to the control channel and the frequency band 1106 corresponding to the audio data channels. In some embodiments, the frequency separation between the first frequency band and the second frequency band is larger than the carrier frequency of the first frequency band divided by 4, e.g., the frequency separation is greater than (1900/4) MHz. In the illustrated embodiment the control channel 1105 and audio data traffic channels (1110, 1112, 1114, . . . , 1116) correspond to different frequency bands, thus the control signals and audio data signals can be received at the same time without interfering with each other.

In accordance with one feature of some embodiments, the wireless microphone transmitters (104, 106 108, . . . , 112) communicate audio data to the wireless microphone receiver 102 using an assigned communications channel, e.g., with each of the channels (1110, 1112, 1114, . . . , 1116) being assigned to a different wireless microphone at a given time. The control channel 1105, in some embodiments, is a time division duplexed channel and is used in some embodiments for (i) transmission of control signals to the wireless microphone transmitters in predetermined time slots dedicated for transmissions from the wireless microphone receiver 102, and (ii) receiving at least one control signal in a predetermined time slot dedicated for receiving control signals from a wireless microphone transmitter e.g., the first wireless microphone 104. Thus in some embodiments the wireless microphone receiver 102 transmits a wireless microphone control signal on the control channel 1105, e.g., during a predetermined time slot reserved for transmission of control information from the wireless microphone 102, while it receives a control signal from a wireless microphone, e.g., during a predetermined time slot reserved for receiving control information from wireless microphones. In accordance with one aspect, the wireless microphone receiver 102 also receives audio signals from a wireless microphone transmitter on audio data channel in the frequency band 1106 which is lower in frequency than the frequency band 1108 corresponding to the control channel 1105.

Lower RF frequencies tend to be more reliable than high RF frequencies for a given transmit power and coding rate. It should be appreciated that the majority of the communication in the wireless microphone system is used for transmission of audio data to a wireless microphone receiver. It should also be appreciated that wireless microphone receivers are, in many embodiments, stationary devices with access to AC power lines while wireless microphone transmitters are often battery powered devices. Taking these various factors into account, in at least some embodiments, lower RF frequencies are used for audio data transmission while higher RF frequencies are used for control signaling to/from wireless microphone transmitters. In this way, wireless microphone transmitters can make the most of their limited available transmit power by using the more reliable lower RF frequencies for the transmission of audio data allowing lower power and/or a lower amount of error correction coding to achieve reliable communication than would be required if higher frequency RF signals were used to communicate the audio data. While control signals are sent using the higher RF frequency band, many of the control signals are transmitted by the wireless microphone receiver which is less power constrained that the individual wireless microphone transmitters since the wireless microphone receiver is normally not limited to battery power. In addition, since the amount of control signaling is relativity small in the system, a higher degree of error correcting coding can be used for the control signaling without significantly impacting the amount of audio data which can be communicated using the limited available frequency resources.

By maintaining a large frequency separation between control signals and audio data signals, the chance of interference between the signals is minimized and in some embodiments, control and audio data communication may occur at the same time. For example, the wireless microphone receiver may transmit control signals and/or control information while one or more wireless microphone transmitters are simultaneously transmitting audio data to the wireless microphone receiver.

In some but not necessarily all embodiments, a wireless microphone transmitter transmit control information to the wireless microphone receiver using a higher transmission power level and/or level of error correcting coding than it uses for transmitting audio data to the wireless microphone transmitter. In some embodiments, the wireless microphone receiver transmits control signaling and/or control information to a wireless microphone transmitter using a transmit power level that is higher than the transmit power level used by the particular wireless microphone transmitter for transmitting control information and/or audio data to the wireless microphone receiver.

In many embodiments while the wireless microphone receivers may wirelessly transmit timing, power control and/or control signals or information over wireless links, in at least some embodiments the wireless microphone transmitters do not wirelessly transmit audio data to any device. In at least some such embodiments a wire or optical line is used to relay received audio information to a recording or other system. However, in other embodiments the wireless microphone receivers may wirelessly transmit audio data received from the wireless microphone transmitters to a recorder or some other device which is not a wireless microphone transmitter.

Various methods and apparatus described in this application are well suited for use in wireless microphone receivers, wireless microphone transmitters and networks supporting wireless microphone communications. In various embodiments a device of any of one or more of FIGS. 1-11 includes a module corresponding to each of the individual steps and/or operations described with regard to any of the Figures in the present application and/or described in the detailed description of the present application. The modules may, and sometimes are implemented in hardware. In other embodiments, the modules may, and sometimes are, implemented as software modules including processor executable instructions which when executed by the processor of the wireless communications device cause the device to implement the corresponding step or operation. In still other embodiments, some or all of the modules are implemented as a combination of hardware and software.

The techniques of various embodiments may be implemented using software, hardware and/or a combination of software and hardware. Various embodiments are directed to apparatus, e.g., wireless microphone receivers, control nodes, wireless microphone transmitters, microphone communications system. Various embodiments are also directed to methods, e.g., method of controlling and/or operating wireless microphone receivers, and wireless microphone transmitters, and microphone communications system. Various embodiments are also directed to a non-transitory machine, e.g., computer, readable medium, e.g., ROM, RAM, CDs, hard discs, etc., which include machine readable instructions for controlling a machine to implement one or more steps of a method.

It is understood that the specific order or hierarchy of steps in the processes disclosed is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

In various embodiments nodes described herein are implemented using one or more modules to perform the steps corresponding to one or more methods, for example, signal receiving, processing, and/or transmission steps. Thus, in some embodiments various features are implemented using modules. Such modules may be implemented using software, hardware or a combination of software and hardware. Many of the above described methods or method steps can be implemented using machine executable instructions, such as software, included in a machine readable medium such as a memory device, e.g., RAM, floppy disk, etc. to control a machine, e.g., general purpose computer with or without additional hardware, to implement all or portions of the above described methods, e.g., in one or more nodes. Accordingly, among other things, various embodiments are directed to a machine-readable medium including machine executable instructions for causing a machine, e.g., processor and associated hardware, to perform one or more of the steps of the above-described method(s). Some embodiments are directed to a device, e.g., microphone device, including a processor configured to implement one, multiple or all of the steps of one or more above described methods.

In some embodiments, the processor or processors, e.g., CPUs, of one or more devices, e.g., microphone devices such as wireless microphone receivers and/or wireless microphone transmitters, are configured to perform the steps of the methods described as being performed by the microphone devices. The configuration of the processor may be achieved by using one or more modules, e.g., software modules, to control processor configuration and/or by including hardware in the processor, e.g., hardware modules, to perform the recited steps and/or control processor configuration. Accordingly, some but not all embodiments are directed to a microphone device, e.g., wireless microphone receiver and/or wireless microphone transmitter, with a processor which includes a module corresponding to each of the steps of the various described methods performed by the device in which the processor is included. In some but not all embodiments a microphone device, e.g., wireless microphone receiver and/or wireless microphone transmitter, includes a module corresponding to each of the steps of the various described methods performed by the device in which the processor is included. The modules may be implemented using software and/or hardware.

Some embodiments are directed to a computer program product comprising a computer-readable medium, e.g., a non-transitory computer-readable medium, comprising code for causing a computer, or multiple computers, to implement various functions, steps, acts and/or operations, e.g. one or more steps described above. Depending on the embodiment, the computer program product can, and sometimes does, include different code for each step to be performed. Thus, the computer program product may, and sometimes does, include code for each individual step of a method, e.g., a method of operating a wireless microphone receiver and/or a wireless microphone transmitter. The code may be in the form of machine, e.g., computer, executable instructions stored on a computer-readable medium such as a RAM (Random Access Memory), ROM (Read Only Memory) or other type of storage device. In addition to being directed to a computer program product, some embodiments are directed to a processor configured to implement one or more of the various functions, steps, acts and/or operations of one or more methods described above. Accordingly, some embodiments are directed to a processor, e.g., CPU, configured to implement some or all of the steps of the methods described herein. The processor may be for use in, e.g., a wireless microphone receiver, a wireless microphone transmitter or other device described in the present application.

While described in the context of an OFDM system, at least some of the methods and apparatus of various embodiments are applicable to a wide range of communications systems including many non-OFDM and/or non-cellular systems.

Numerous additional variations on the methods and apparatus of the various embodiments described above will be apparent to those skilled in the art in view of the above description. Such variations are to be considered within the scope. The methods and apparatus may be, and in various embodiments are, used with CDMA, orthogonal frequency division multiplexing (OFDM), and/or various other types of communications techniques which may be used to provide wireless communications links between the microphone devices. In some embodiments, a wireless microphone receiver is implemented as a stationary device and communicates with microphone transmitters using OFDM and/or CDMA and may provide connectivity to a recording system, an amplification system, a processing, e.g., filtering system, and/or an output system, e.g., a speaker system. In various embodiments the microphone devices are implemented as portable devices including receiver/transmitter circuits and logic and/or routines, for implementing the methods. In some embodiments, at least some wireless microphone receivers, which are implemented as stationary devices, in the wireless microphone communications system use AC power. In some embodiments, at least some of the wireless microphone transmitters, which are mobile devices, use battery power.

What is claimed is:

1. A method of operating a wireless microphone receiver, comprising:
transmitting a timing reference signal;
receiving a first signal from a first wireless microphone transmitter; and
transmitting, to the first wireless microphone transmitter, a first closed loop symbol timing control signal used to control symbol timing of said first wireless microphone transmitter.

2. The method of claim 1, further comprising:
receiving a second signal from a second wireless microphone transmitter; and
transmitting a second closed loop symbol timing control signal from the wireless microphone receiver, said second closed loop symbol timing control signal controlling symbol timing of said second wireless microphone transmitter.

3. The method of claim 1, wherein said first closed loop symbol timing control signal instructs the first wireless microphone transmitter to advance or delay symbol timing.

4. The method of claim 3, wherein said second closed loop symbol timing control signal instructs the second wireless microphone transmitter to advance or delay symbol timing.

5. The method of claim 2, further comprising, prior to transmitting said first closed loop symbol timing control signal determining a symbol timing adjustment to be made by the first wireless microphone transmitter to synchronize to a target symbol receive time to which multiple wireless microphone transmitters are synchronized.

6. The method of claim 5, wherein said first and second closed loop symbol timing control signals are transmitted over a control channel, said control channel using a first frequency band which is different from a second frequency band used for the communication of audio signals.

7. A wireless microphone receiver, comprising:
means for transmitting a timing reference signal;
means for receiving a first signal from a first wireless microphone transmitter; and
means for transmitting, to the first wireless microphone transmitter, a first closed loop symbol timing control signal used to control symbol timing of said first wireless microphone transmitter.

8. The wireless microphone receiver of claim 7, further comprising:
means for receiving a second signal from a second wireless microphone transmitter; and
means for transmitting a second closed loop symbol timing control signal from the wireless microphone receiver, said second closed loop symbol timing control signal controlling symbol timing of said second wireless microphone transmitter.

9. The wireless microphone receiver of claim 7, wherein said first closed loop symbol timing control signal instructs the first wireless microphone transmitter to advance or delay symbol timing; and
wherein said second closed loop symbol timing control signal instructs the second wireless microphone transmitter to advance or delay symbol timing.

10. The wireless microphone receiver of claim 8, further comprising:
means for determining a symbol timing adjustment to be made by the first wireless microphone transmitter to synchronize to a target symbol receive time to which multiple wireless microphone transmitters are synchronized.

11. A wireless microphone receiver, comprising:
at least one processor configured to:
transmit a timing reference signal;
receive a first signal from a first wireless microphone transmitter; and
transmit, to the first wireless microphone transmitter, a first closed loop symbol timing control signal used to control symbol timing of said first wireless microphone transmitter; and
a memory coupled to said at least one processor.

12. The wireless microphone receiver of claim 11, wherein said at least one processor is further configured to:
receive a second signal from a second wireless microphone transmitter; and
transmit a second closed loop symbol timing control signal from the wireless microphone receiver, said second closed loop symbol timing control signal controlling symbol timing of said second wireless microphone transmitter.

13. The wireless microphone receiver of claim 11, wherein said first closed loop symbol timing control signal instructs the first wireless microphone transmitter to advance or delay symbol timing; and
wherein said second closed loop symbol timing control signal instructs the second wireless microphone transmitter to advance or delay symbol timing.

14. The wireless microphone receiver of claim 12, wherein said at least one processor is further configured to determine a symbol timing adjustment to be made by the first wireless microphone transmitter to synchronize to a target symbol receive time to which multiple wireless microphone transmitters are synchronized.

15. A computer program product for use in a wireless microphone receiver, the computer program product comprising:
a non-transitory computer readable medium comprising:
code for causing at least one computer to transmit a timing reference signal;
code for causing the at least one computer to receive a first signal from a first wireless microphone transmitter; and
code for causing the at least one computer to transmit, to the first wireless microphone transmitter, a first closed loop symbol timing control signal used to control symbol timing of said first wireless microphone transmitter.

16. A method of operating a first wireless microphone transmitter, comprising:
receiving a timing reference signal transmitted by a wireless microphone receiver within communications range of said first wireless microphone transmitter;
transmitting a signal to the wireless microphone receiver; and
receiving a closed loop symbol timing control signal from the wireless microphone receiver, said closed loop symbol timing control signal controlling symbol timing of said first wireless microphone transmitter.

17. The method of claim 16, further comprising:
performing, prior to transmitting said signal to the wireless microphone receiver, an open loop symbol timing synchronization operation based on the timing reference signal received from the wireless microphone receiver.

18. The method of claim 16, wherein said closed loop symbol timing control signal instructs said first wireless microphone transmitter to advance or delay the symbol timing of said first wireless microphone transmitter.

19. The method of claim 17, further comprising:
performing a symbol timing adjustment operation to adjust the symbol timing of said first wireless microphone transmitter to synchronize to a target symbol receive time to which multiple wireless microphone transmitters are synchronized in accordance with the closed loop symbol timing control signal.

20. The method of claim 16, wherein said closed loop timing control signal is received over a control channel, said control channel using a first frequency band which is different from a second frequency band used for the communication of audio signals.

21. A first wireless microphone transmitter, comprising:
means for receiving a timing reference signal transmitted by a wireless microphone receiver within communications range of said first wireless microphone transmitter;
means for transmitting a signal to the wireless microphone receiver; and
means for receiving a closed loop symbol timing control signal from the wireless microphone receiver, said closed loop symbol timing control signal controlling symbol timing of said first wireless microphone transmitter.

22. The first wireless microphone transmitter of claim 21, further comprising:
means for performing an open loop symbol timing synchronization operation based on the timing reference signal received from the wireless microphone receiver.

23. The first wireless microphone transmitter of claim 21, wherein said closed loop symbol timing control signal instructs said first wireless microphone transmitter to advance or delay the symbol timing of said first wireless microphone transmitter.

24. The first wireless microphone transmitter of claim 22, further comprising:
means for performing a symbol timing adjustment operation to adjust the symbol timing of said first wireless microphone transmitter to synchronize to a target symbol receive time to which multiple wireless microphone transmitters are synchronized, in accordance with the closed loop symbol timing control signal.

25. The first wireless microphone transmitter of claim 21, wherein said closed loop timing control signal is received over a control channel, said control channel using a first frequency band which is different from a second frequency band used for the communication of audio signals.

26. A first wireless microphone transmitter, comprising:
at least one processor configured to:
receive a timing reference signal transmitted by a wireless microphone receiver within communications range of said first wireless microphone transmitter;
transmit a signal to the wireless microphone receiver; and
receive a closed loop symbol timing control signal from the wireless microphone receiver, said closed loop symbol timing control signal controlling symbol timing of said first wireless microphone transmitter; and
a memory coupled to said at least one processor.

27. The first wireless microphone transmitter of claim 26, wherein said at least one processor is further configured to:
perform an open loop symbol timing synchronization operation based on the timing reference signal received from the wireless microphone receiver.

28. The first wireless microphone transmitter of claim 26, wherein said closed loop symbol timing control signal instructs said first wireless microphone transmitter to advance or delay the symbol timing of said first wireless microphone transmitter.

29. The first wireless microphone transmitter of claim 27, wherein said at least one processor is further configured to:
perform a symbol timing adjustment operation to adjust the symbol timing of said first wireless microphone transmitter to synchronize to a target symbol receive time to which multiple wireless microphone transmitters are synchronized, in accordance with the closed loop symbol timing control signal.

30. A computer program product for use in a first wireless microphone transmitter, the computer program product comprising:
a non-transitory computer readable medium comprising:
code for causing at least one computer to receive a timing reference signal transmitted by a wireless microphone receiver within communications range of said first wireless microphone transmitter;
code for causing the at least one computer to transmit a signal to the wireless microphone receiver; and
code for causing the at least one computer to receive a closed loop symbol timing control signal from the wireless microphone receiver, said closed loop symbol timing control signal controlling symbol timing of said first wireless microphone transmitter.
